(19) United States
(12) Patent Application Publication
(10) Pub. No.: US 2013/0138654 A1
(43) Pub. Date: May 30, 2013

(54) METHODS AND APPARATUSES FOR GENERATING SEMANTIC SIGNATURES FOR MEDIA CONTENT

(71) Applicants: Sailesh Kumar Sathish, Tampere (FI); Sujeet Shyamsundar Mate, Tampere (FI)

(72) Inventors: Sailesh Kumar Sathish, Tampere (FI); Sujeet Shyamsundar Mate, Tampere (FI)

(73) Assignee: NOKIA CORPORATION, Espoo (FI)

(21) Appl. No.: 13/307,831

(22) Filed: Nov. 30, 2011

(51) Int. Cl. G06F 17/30

(52) U.S. Cl. 707/738; 707/E17.014; 707/E17.001

(57) ABSTRACT

Methods and apparatuses are provided for generating, storing, and/or distributing semantic media signatures for media content. A method may comprise receiving media content to be analyzed for generating a semantic signature. The method may further comprise processing the media content to determine one or more media segments of the media content. Additionally, the method may comprise identifying one or more topics represented by the media content. The method may further comprise associating one or more media segments with each of the one or more topics. The one or more media segments associated with a topic may contain a representation of the topic. The method may additionally comprise generating a semantic signature for the media content. The semantic signature may comprise an indication of the one or more identified topics and the one or more media segments associated with each topic. Corresponding apparatuses are also provided.

### TECHNOLOGICAL FIELD

Example embodiments of the present invention relate generally to representing media content and, more particularly, relate to methods and apparatuses for generating, storing, and/or distributing semantic media signatures for media content.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of all socioeconomic backgrounds.

The various improvements to computing devices have led to an enormous increase in the amount of media content captured and stored by users. Additionally, it has become more common to distribute media content. Searching this vast amount of media content and locating a desired piece of media may be cumbersome for a user. Accordingly, to meet the demands of users or encourage utilization of new functionality, innovation in media content representation and search must keep pace.

### BRIEF SUMMARY

Example methods, example apparatuses, and example computer program products are described herein that provide for generating, storing, and/or distributing semantic media signatures for media content. In a first example embodiment, a method is provided. The example method may comprise receiving media content to be analyzed for generating a semantic signature; processing the media content to determine one or more media segments of the media content; identifying one or more topics represented by the media content; associating one or more media segments with each of the one or more topics; and generating a semantic signature for the media content. In this example embodiment, the one or more media segments associated with a topic may contain a representation of the topic, and the semantic signature may comprise an indication of the one or more identified topics and the one or more media segments associated with each topic. In another example embodiment, a computer program may be provided for executing the various operations of the example method.

In another example embodiment, an apparatus comprising at least one processor and at least one memory storing computer program code is provided. In this regard, the example apparatus may be caused to receive media content to be analyzed for generating a semantic signature; process the media content to determine one or more media segments of the media content; identify one or more topics represented by the media content; associating one or more media segments with each of the one or more topics; and generate a semantic signature for the media content. In this example embodiment, the one or more media segments associated with a topic may contain a representation of the topic, and the semantic signature may comprise an indication of the one or more identified topics and the one or more media segments associated with each topic.

In another example embodiment, a computer program product is provided. The computer program product of this example embodiment may comprise at least one non-transitory computer-readable storage medium having computer program code stored thereon, wherein the computer program code, when executed by an apparatus (e.g., one or more processors), causes an apparatus to perform various functionalities. In this regard, the program code may cause the apparatus to receive media content to be analyzed for generating a semantic signature; process the media content to determine one or more media segments of the media content; identify one or more topics represented by the media content; associating one or more media segments with each of the one or more topics; and generate a semantic signature for the media content. In this example embodiment, the one or more media segments associated with a topic may contain a representation of the topic, and the semantic signature may comprise an indication of the one or more identified topics and the one or more media segments associated with each topic.

In another example embodiment, an apparatus is provided that may comprise means for receiving media content to be analyzed for generating a semantic signature; means for processing the media content to determine one or more media segments of the media content; means for identifying one or more topics represented by the media content; means for associating one or more media segments with each of the one or more topics; and means for generating a semantic signature for the media content. In this example embodiment, the one or more media segments associated with a topic may contain a representation of the topic, and the semantic signature may comprise an indication of the one or more identified topics and the one or more media segments associated with each topic.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example representation of a semantic signature according to various embodiments;

FIG. 2 illustrates a block diagram of an apparatus for generating, storing, and/or distributing semantic media signatures for media content according to some example embodiments;

FIG. 3 is a schematic block diagram of a mobile terminal according to some example embodiments;

FIG. 4 illustrates an example semantic signature management framework according to some example embodiments; and

FIG. 5 illustrates a flowchart according to an example method for generating, storing, and/or distributing semantic media signatures for media content according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

According to various embodiments, methods, apparatuses, and computer program products are provided that create semantic signatures for media content. In this regard, according to some example embodiments, an apparatus is described that generates, stores, and/or distributes semantic media signatures for media content. A semantic signature may comprise information for identifying, accessing, browsing, modifying, recombining, and searching the media content. In some embodiments, a descriptor signature may be a basic form (e.g., a subset) of the semantic signature comprising only a unique identifier and a uniform resource locator (URL) linked to the media content. In this regard, the descriptor signature may further provide a link to the semantic signature for the corresponding media content. It should be understood that a uniform resource identifier (URI) may replace or supplement the URL of this embodiment or any other embodiment described herein.

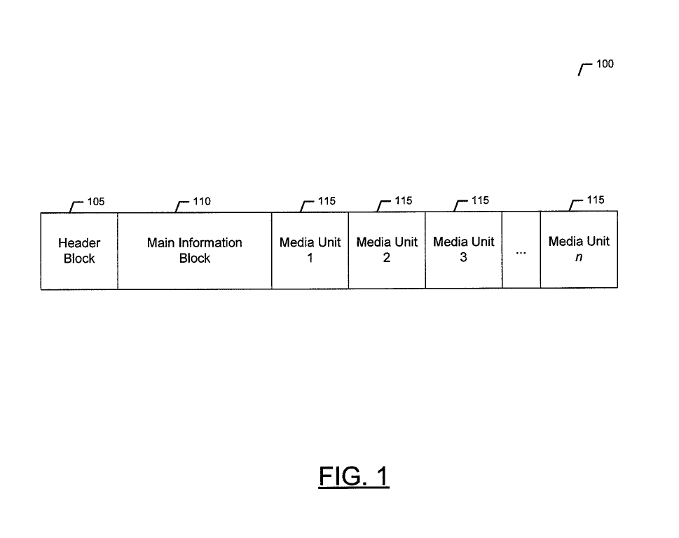

The semantic signature of example embodiments may be generated by processing and/or analyzing media content to determine one or more topics, each corresponding to one or more segments of the media content. A media segment may comprise one or more consecutive units (e.g., frames) of the media content. Each topic may be represented by a media unit in the semantic signature, as will be described in further detail below with respect to FIG. 1. Some topics may have sub-topics, which may be represented by separate media units. Accordingly, each sub-topic represented by a media unit in the semantic signature of the parent topic may further be represented by its own semantic signature. In some embodiments, the semantic signature may comprise a media unit corresponding to the one or more media segments of the media content not mapped to a particular topic. In these instances, the media unit may have no topic designator or may have a generic topic designator, for example “general.”

The hierarchy of relationships between the topics and sub-topics may be identified based on a system of levels. For example, a semantic signature for a topic (or sub-topic) may designate the media unit representing that particular topic (or sub-topic) as level zero (i.e., level 0). Sibling media units (e.g., media units representing a topic similar to the level 0 topic) and/or generic media units (as described above) may also be designated as level 0. That same semantic signature may further contain media units corresponding to one or more parent topics (or sub-topics), which may be designated as level minus one (i.e., level −1) within the corresponding media unit, and/or one or more child sub-topics, which may be designated as level one (i.e., level 1) within the corresponding media unit. In this example, the semantic signature may designate a grandparent of its corresponding topic (or sub-topic) as level minus two (i.e., level −2), a grandchild as level two (i.e., level 2), and so forth. All levels may be indicated with respect to the current topic level, that is, the current topic level whose corresponding media units are designated as ground level (i.e., level 0).

FIG. 1 illustrates an example representation of a semantic signature according to various embodiments. FIG. 1 depicts a semantic signature 100 comprising a header block 105, main information block 110, and one or more media units 115. It should be understood that many variations to the structure and content of the example representation of FIG. 1 may be made without departing from the scope of the present invention.

In some embodiments, the header block 105 of the example semantic signature 100 may be a standard, fixed length (e.g., five bytes). Alternatively, the header block 105 may be of variable length. In either instance, the header block 105 may comprise an indication of the length of the header block 105. The header block 105 may further comprise an indication of a unique identifier, for example a universally unique identifier (UUID), which may be associated with the media content represented by the semantic signature 100. Further, the header block 105 may comprise an indication of the length for each block following the header block 105. In this regard, one or more key-value pairs may be included in the header block 105, such that each key identifies a particular block and each corresponding value indicates the length of the block. Such signature byte mapping may, therefore, provide an index to a particular block in the semantic signature 100. The header block 105 may also indicate the type of media content represented by the semantic signature 100. For example, the media type may indicate that the media content is playback video, an album (e.g., image album or video album), text description, or the like.

The main information block 110 of the example semantic signature 100 depicted in FIG. 1 may be variable length. In this regard, the length of the main information block 110 may be known from the header block 105. The main information block 110 may comprise one or more key-value pairs, which may be binary keys in certain embodiments. Some example key-value pairs of the main information block 110 may indicate one or more of (1) a URL for the repository that contains schema for the main information block 110; (2) the length of the main information block 110 (which may be optional in embodiments where the header block 105 indicates the length); (3) a UUID for the media content represented at level 0 of this particular sematic signature (in some instances including sibling level 0 media content from the local (not external) media content, which therefore corresponds to the same UUID); (4) the number of locations where the media content is available; (5) one or more links (e.g., URLs) to the locations where the media content is available; (6) one or more locations where the media content was recorded; (7) owner information; (8) copyright information (e.g., a key-value pair indicating the type of copyright and/or a key-value pair indicating a URL to the copyright information); (9) the number of topics contained within the semantic signature 100; (10) the number of child and/or parent topics contained within the semantic signature 100; (11) the number of hierarchy levels present in the semantic signature 100, and/or the like. In various embodiments, the main information block 110 may indicate the location and size (e.g., length) of each of the media units 115 represented in the semantic signature 100. For example, the main information block 110 may represent a child media unit 115 located at the 85^{th} byte of the semantic signature 100 using the key-value pair (level 1, byte 85).

The media unit 115 of the example semantic signature 100 illustrated in FIG. 1 may also be of variable length. In this regard, the media unit 115 may comprise an indication of the size (e.g., length) of the media unit 115. As noted above, the media units 115 of the semantic signature 100 may provide information about the actual media content represented by the semantic signature 100. For example, a media unit 115 may comprise an indication of the media type, media owner, access options, and/or the like related to the media content represented therein. An access option may comprise, for example, an indication that the media unit 115 is available for viewing online only, not downloadable, not shareable, not to be included in other media units, not to be modified, require owner permission for linking, and/or the like. A media unit 115 may comprise a UUID associated with the media content it represents. The media unit 115 may further comprise a URL to a location where the media content may be accessed. In instances in which the represented media content is stored in more than one location (e.g., both local storage and external storage), the media unit 115 may comprise a different URL for each location. In some embodiments in which the semantic signature 100 comprises multiple level 0 media units 115, the UUID contained in the main information block 110 of the semantic signature 100 may be representative of each level 0 media unit 115, though not identical to the UUID contained in the level 0 media units 115. According to these embodiments, the UUID of the main information block 110 may be the same as the UUID of a level 0 media unit 115 only when there are no other level 0 media units 115 and the URL(s) of the level 0 media unit 115 are the same as the URL(s) of the semantic signature 100. In other embodiments, the UUID and/or URL may only be included in the media unit 115 if the UUID of the media unit 115 is different than the UUID of the containing semantic signature 100. That is, in these embodiments, the media unit 115 may comprise the UUID and/or URL of the media content only in those instances where (1) the media unit 115 is not level 0, (2) there are multiple level 0 media units each having a unique UUID, or (3) the media unit 115 is an external sibling of the level 0 media unit 115.

In some embodiments, each media unit 115 may represent a single topic of the media content or the one or more media segments of the media content not mapped to a particular topic. One or more sub-topics of that topic may further be represented by their own media units 115. The media units 115 may indicate the level of media content they represent. For example, the media unit 115 for the media content represented by the particular semantic signature 100 containing the media unit 115 may comprise an indication of level 0. That is, the media unit 115 having the same UUID as the containing semantic signature 100 may indicate level 0. In this example, the same semantic signature 100 may comprise a parent media unit 115 (i.e., a media unit 115 representing a topic from which the level 0 media unit 115 is a sub-topic) indicating level −1 and/or a child media unit 115 (i.e., a media unit 115 representing a sub-topic of the topic represented by the level 0 media unit 115) indicating level 1. In certain instances, a sibling media unit 115 (i.e., a media unit 115 representing a topic similar to the topic represented by the level 0 media unit 115) of the level 0 media unit 115 may also indicate level 0. The parent, child, and sibling media units 115 may further be represented by their own separate semantic signatures 100 comprising the same UUID and/or URL information indicated in the corresponding media unit 115 contained in this semantic signature 100. Thus, the UUID and/or URL contained in the parent, child, or sibling media unit 115 in this semantic signature 100 may serve as a link or pointer to the semantic signature 100 for the corresponding media content represented by the parent, child, or sibling media unit 115.

According to example embodiments, a media unit 115 may comprise information about the topic represented by the media unit 115. For example, the media unit 115 may comprise a label specifying the topic (e.g., a key-value pair or text label). The media unit 115 may also comprise an indication of the one or more media segments of the media content associated with the topic. For example, a topic represented by a media unit 115 may comprise various distinct (i.e., non-consecutive) media segments of the media content. In this regard, the media unit 115 may specify the media frame intervals along with the start address of the first frame of the corresponding segment for each of the one or more media segments of the media content associated with the topic. In some embodiments, a snapshot or preview of the media content associated with the topic represented by the media unit 115 may be included in the media unit 115. For example, the media unit 115 may comprise a URL for a low-bandwidth version of the media content. In another example, the media unit 115 may comprise one or more frames or stills of the media content represented by the media unit 115.

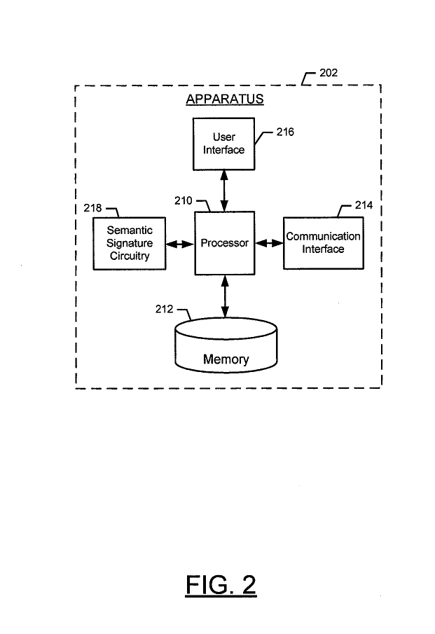

Referring now to FIG. 2, FIG. 2 illustrates a block diagram of an apparatus 202 for generating, storing, and/or distributing semantic media signatures for media content according to some example embodiments. It will be appreciated that the apparatus 202 is provided as an example of some embodiments and should not be construed to narrow the scope or spirit of the invention in any way. In this regard, the scope of the disclosure encompasses many potential embodiments in addition to those illustrated and described herein. As such, while FIG. 2 illustrates one example of a configuration of an apparatus for generating, storing, and/or distributing semantic media signatures for media content, other configurations may also be used to implement embodiments of the present invention.

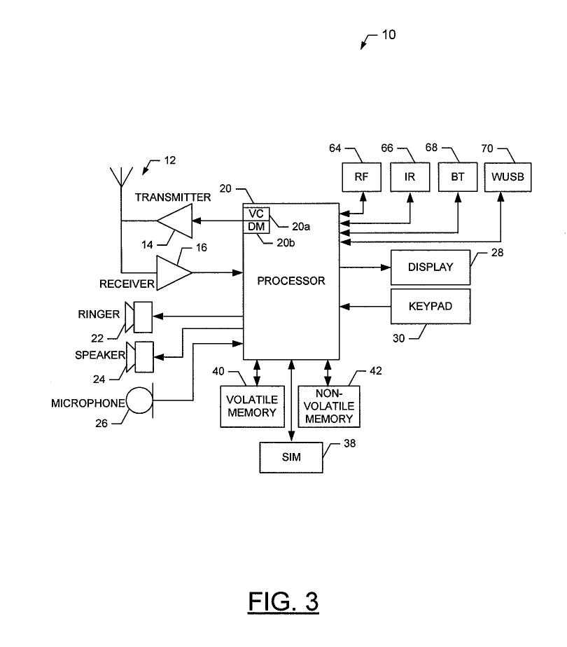

The apparatus 202 may be embodied as a desktop computer, laptop computer, mobile terminal, mobile computer, mobile phone, mobile communication device, game device, digital camera/camcorder, audio/video player, television device, digital video recorder, positioning device, chipset, a computing device comprising a chipset, any combination thereof, and/or the like. In this regard, the apparatus 202 may comprise any computing device or other apparatus that is configured to facilitate generating, storing, and/or distributing semantic media signatures for media content in accordance with one or more example embodiments disclosed herein. In some example embodiments, the apparatus 202 is embodied as a mobile computing device, such as the mobile terminal illustrated in FIG. 3.

In this regard, FIG. 3 illustrates a block diagram of a mobile terminal 10 representative of some embodiments of an apparatus 202. It should be understood, however, that the mobile terminal 10 illustrated and hereinafter described is merely illustrative of one type of apparatus 202 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), future communication, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. One or more of the volatile memory 40 or non-volatile memory 42 may be embodied as a tangible, non-transitory memory. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 2, in some example embodiments, the apparatus 202 includes various means for performing the various functions herein described. These means may comprise one or more of a processor 210, memory 212, communication interface 214, user interface 216, or semantic signature circuitry 218. The means of the apparatus 202 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 210), or some combination thereof.

In some example embodiments, one or more of the means illustrated in FIG. 2 may be embodied as a chip or chip set. In other words, the apparatus 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 210, memory 212, communication interface 214, user interface 216, and/or semantic signature circuitry 218 may be at least partially embodied as a chip or chip set. The apparatus 202 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 210 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 2 as a single processor, in some embodiments the processor 210 comprises a plurality of processors. The plurality of processors may be in operative communication with each other and may be collectively configured to perform one or more functionalities of the apparatus 202 as described herein. The plurality of processors may be embodied on a single computing device or distributed across a plurality of computing devices collectively configured to function as the apparatus 202. In embodiments wherein the apparatus 202 is embodied as a mobile terminal 10, the processor 210 may be embodied as or comprise the processor 20. In some example embodiments, the processor 210 is configured to execute instructions stored in the memory 212 or otherwise accessible to the processor 210. These instructions, when executed by the processor 210, may cause the apparatus 202 to perform one or more of the functionalities of the apparatus 202 as described herein. As such, whether configured by hardware or software methods, or by a combination thereof, the processor 210 may comprise an entity capable of performing operations according to one or more example embodiments while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may comprise, for example, volatile memory, non-volatile memory, or some combination thereof. In this regard, the memory 212 may comprise a non-transitory computer-readable storage medium. Although illustrated in FIG. 2 as a single memory, the memory 212 may comprise a plurality of memories. The plurality of memories may be embodied on a single computing device or may be distributed across a plurality of computing devices collectively configured to function as the apparatus 202. In various example embodiments, the memory 212 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 202 is embodied as a mobile terminal 10, the memory 212 may comprise the volatile memory 40 and/or the non-volatile memory 42. The memory 212 may be configured to store information, data, applications, instructions, or the like for enabling the apparatus 202 to carry out various functions in accordance with various example embodiments. For example, in some example embodiments, the memory 212 is configured to buffer input data for processing by the processor 210. Additionally or alternatively, the memory 212 may be configured to store program instructions for execution by the processor 210. The memory 212 may store information in the form of static and/or dynamic information.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to another computing device. In an example embodiment, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with one or more remote computing devices. The communication interface 214 may be configured to receive and/or transmit data using any protocol that may be used for communications between computing devices. In this regard, the communication interface 214 may be configured to receive and/or transmit data using any protocol that may be used for transmission of data over a wireless network, wireline network, some combination thereof, or the like by which the apparatus 202 and one or more computing devices may be in communication. The communication interface 214 may additionally be in communication with the memory 212, user interface 216, and/or semantic signature circuitry 218, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. In embodiments wherein the user interface 216 comprises or is in communication with a display, the display may comprise, for example, a cathode ray tube (CRT) display, a plasma display panel (PDP), a liquid crystal display (LCD), a light-emitting diode (LED), an organic light-emitting diode display (OLED), a projector (e.g., a projector configured to project a display on a projection screen, wall, and/or other object), a holographic display, or the like. In embodiments wherein the user interface 216 comprises a touch screen display, the user interface 216 may additionally be configured to detect and/or receive an indication of a touch gesture or other input to the touch screen display. The user interface 216 may be in communication with the memory 212, communication interface 214, and/or semantic signature circuitry 218, such as via a bus.

The semantic signature circuitry 218 may be embodied as various means, such as circuitry, hardware, a computer program product comprising computer readable program instructions stored on a computer readable medium (e.g., the memory 212) and executed by a processing device (e.g., the processor 210), or some combination thereof and, in some embodiments, is embodied as or otherwise controlled by the processor 210. In embodiments wherein the semantic signature circuitry 218 is embodied separately from the processor 210, the semantic signature circuitry 218 may be in communication with the processor 210. The semantic signature circuitry 218 may further be in communication with one or more of the memory 212, communication interface 214, user interface 216, such as via a bus.

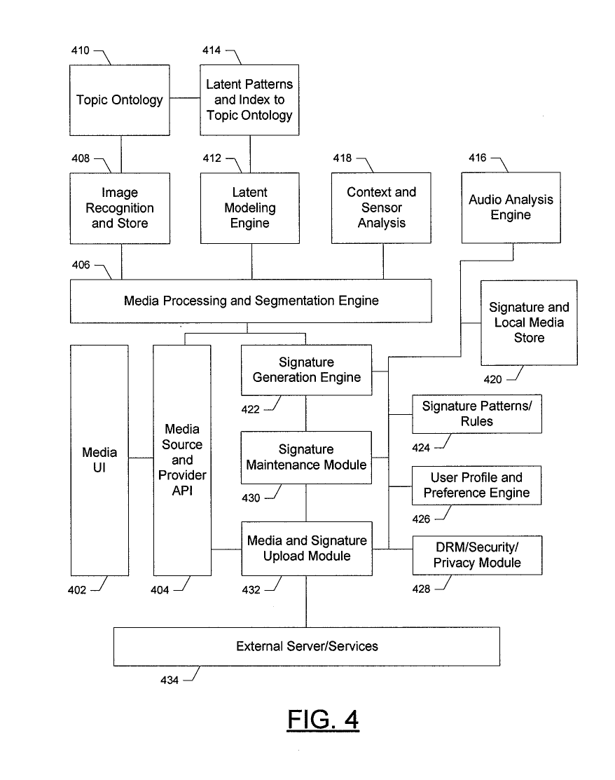

The following example embodiments will be described with reference to the example semantic signature management framework illustrated in FIG. 4, however, it should be understood that embodiments of the present invention are not to be limited to this particular framework or the specific embodiments disclosed and that modifications and other embodiments are intended to be included within the scope of the invention.

According to various embodiments, the semantic signature circuitry 218 may comprise the various modules and engines illustrated in FIG. 4, and therefore, may be configured to perform their functions. The modules and engines may be software modules, hardware modules, or a combination of both. The semantic signature circuitry 218 may be further configured to access and control the various rules and media stores illustrated in FIG. 4.

The semantic signature circuitry 218 may be configured to select, receive, or upload media content for which a semantic signature should be generated. For example, a user or service may provide the media content to the Media User Interface (UI) module 402. In some embodiments, the Media UI module 402 may be accessible via the Media Source and Provider Application Provider Interface (API) module 404. The Media Source and Provider API module 404 may be, for example, a bidirectional API used by providers (e.g., users, services, Media UI module 402) for sourcing media content and/or signatures from one or more storage options (e.g., Signature and Local Media Store 420). In this way, any module requiring access to the various storage options may utilize the Media Source and Provider API module 404. Thus, the Media Source and Provider API module 404 may, in certain embodiments, serve as a central routing module for data transactions.

Once the media content is received via the Media UI 402, the semantic signature circuitry 218 may be configured to pass the media content to the Media Processing and Segmentation Engine 406. The Media Processing and Segmentation Engine 406 may be configured to interface with various utilities for segmenting the media content. In some embodiments, the segmentation criteria may be provided by a user (e.g., via the Media UI 402). For example, the user may determine the segments manually and provide topic annotations for each segment. In other embodiments, one or more segmentation heuristics may be employed by the Media Processing and Segmentation Engine 406 to segment the media content. For example, the media content may be segmented by characteristics identifiable in the media content, such as scene changes. In yet other embodiments, the segmentation may be performed automatically based on one or more segmentation heurisitcs, and one or more of the segments may be confirmed by the user.

According to example embodiments, the semantic signature circuitry 218 may be configured to tag or label (e.g., with a topic identifier) the various identified media segments of the media content via, for example, one or more segmentation technology modules operating in conjunction with the Media Processing and Segmentation Engine 406. In this regard, the Media Processing and Segmentation Engine 406 may determine the possible segmentations of the media content based on the heuristics and/or user input and call one or more of the segmentation technology modules. In some embodiments, various potential segmentations may be identified, and input from the one or more segmentation technology modules may be used to determine which segmentations should be made. Some segmentation technology modules may be configured to map one or more of the segments to a particular topic. Other segmentation technology modules may provide context or other information that may be used by, for example, the Media Processing and Segmentation Engine 406 to associate a topic with one or more media segments. Once the media segments and associated topics are identified, the Media Processing and Segmentation Engine 406 may be configured to store the data in the Signature and Local Media Store 420.

The Media Processing and Segmentation Engine 406 and associated segmentation technology modules may rely on a topic identifier ontology to derive the topic identifiers to be associated with the one or more media segments. In this regard, the topic identifier ontology may be a hierarchical representation of topic identifiers (e.g., noun tokens), such that relationships among the various topics may be expressed. Further, the hierarchical structure may allow the topic identifiers to provide different levels of granularity related to the topics. In example embodiments, the topic identifier ontology may be a standardized topic identifier ontology, or in other embodiments, the topic identifier ontology may be generated and/or maintained by a third party (e.g., the producer of the media content).

One segmentation technology module that may be associated with the Media Processing and Segmentation Engine 406 is the Latent Topic Modeling Engine 412. According to example embodiments, the Latent Topic Modeling Engine 412 may determine the distribution of a fixed set of latent parameters and discover which of the latent parameters are contained in the media segments. For example, the Latent Topic Modeling Engine 412 may provide latent factorization to the media segments identified during the segmentation process. Two types of data may be used to identify the latent model in the media segment: (1) the media content of the media segment itself (e.g., video data), and (2) user-provided data (e.g., annotations on the media segment). Using this data, the Latent Topic Modeling Engine 412 may identify the latent topic distribution among the media segments. The Latent Topic Modeling Engine 412 may then build a latent pattern indicating the distribution of latent topics among the media segments. A Topic Ontology module 410 in association with the Latent Topic Modeling Engine 412 may store a known pattern for each topic. To determine which topics are associated with which media segments, the Latent Topic Modeling Engine 412 may match the constructed latent patterns with the stored known patterns. In some instances, the matching may be facilitated by the Latent Patterns and Index to Topic Ontology module 414.

Another segmentation technology module that may be associated with the Media Processing and Segmentation Engine 406 is the Image Recognition and Store module 408. The Image Recognition and Store module 408 may be configured to identify one or more images in the media segments. In some instance, the Image Recognition and Store module 408 may identify multiple instances (e.g., co-occurrence and/or co-location) of the same image or set of images within the media segments. According to example embodiments, the identification of the one or more images may allow the semantic signature circuitry 218 to determine which topics are represented by which media segments. In this regard, the Image Recognition and Store module 408 may store indications of known images in association with a particular topic. To determine which topics are associated with which media segments, the Image Recognition and Store module 408 may match the identified one or more images from a media segment to the known images in the data store. Accordingly, a topic may be associated with a particular media segment.

Yet another segmentation technology module that may be associated with the Media Processing and Segmentation Engine 406 is the Audio Analysis Engine 416. The Audio Analysis Engine 416 may be configured to analyze the audio portion of the media segments, including background and ambient sound. In certain embodiments, the identified audio may be used by the Audio Analysis Engine 416 to infer the content and/or context of the media segment. For example, audio identified as automobile noise may provide an indication that the media segment comprises representations of automobiles. In this example, the identified automobile noise may additionally or alternatively indicate that the media segment was recorded proximate a street or in an urban environment. According to example embodiments, the Audio Analysis Engine 416 may be configured to detect particular audio events associated with the context of a particular topic. For example, the Audio Analysis Engine 416 may attempt to detect the sound of cutlery, trains, birds, water, and/or the like. In these instances, if the audio event is detected in a media segment, the corresponding topic may be associated with the media segment.

Still another segmentation technology module that may be associated with the Media Processing and Segmentation Engine 406 is the Context and Sensor Analysis module 418. The Context and Sensor Analysis module 418 may be configured to provide additional information about the media segments. In example embodiments, the Context and Sensor Analysis module 418 may rely on information provided by positioning sensors (e.g., Global Positioning Systems (GPS), Indoor Positioning System (IPS), cell ID, WiFi ID, and/or the like), time data, weather sensors (e.g., thermometers), altitude sensors, attitude sensors, and/or the like. Similar to the audio signatures identified by the Audio Analysis Engine 416, the output of the Context and Sensor Analysis module 418 may provide information on the content and/or context of the media segments. The output of the Context and Sensor Analysis module 418 may, in some embodiments, be used in conjunction with information from the other segmentation technology modules to determine topic information related to the media segments.

According to example embodiments, the semantic signature circuitry 218 may provide the media segments and associated topic information to the Signature Generation Engine 422 to create the semantic signature. In some embodiments, prior to providing the data to the Signature Generation Engine 422, the semantic signature circuitry 218 may provide an interface for user input related to the identified media segments and associated topics, such that the user may modify the media segments and/or topics determined by the Media Processing and Segmentation Engine 406 and associated segmentation technology modules. The modifications provided by the user in these instances may be used to update the media segments and topic information stored in the Signature and Local Media Store 420. In an instance in which a topic input by the user is not currently present in the Topic Ontology 410, the Topic Ontology 410 may be updated to include the user-input topic.

The Signature Generation Engine 422 may further receive various forms of information related to the media content. For example, the Signature Generation Engine 422 may receive information indicating the media type, media length, media segment locations, and/or the like. The User Profile and Preference Engine 426 may provide various forms of user information and preferences to be considered when generating the semantic signature. The Digital Rights Management (DRM)/Security/Privacy module 428 may provide DRM, security, and privacy information related to the one or more media segments. For example, the information provided by the DRM/Security/Privacy module 428 may be used to determine which information (e.g., key pairs) included in the semantic signature should be published and, therefore, available to the public. The Signature Patterns and Rules module 424 may provide one or more signature patterns (e.g., templates, schema, or the like) that may be used to configure the semantic signature. For example, a particular external service may have a preferred format for the semantic signature (e.g., binary, Extensible Markup Language (XML), and/or the like), which may be represented by a signature pattern in the Signature Patterns and Rules module 424.

According to various embodiments, the Signature Generation Engine 422 may generate a semantic signature using the information and data provided. For example, the Signature Generation Engine 422 may generate a semantic signature having the format described above with respect to FIG. 1. In this regard, the Signature Generation Engine 422 may generate a UUID and create a header block, main information block, and one or more media units (each with the corresponding information described above with respect to FIG. 1) for each semantic signature. In example embodiments, the Signature Generation Engine 422 may generate a separate semantic signature for each topic identified in the media content. One or more of the semantic signatures representing related media content may be linked to one another using the UUIDs and/or URLs associated with the semantic signatures. In this regard, the relationship between topics and sub-topics may be indicated using the level system described above. Further, the semantic signature may comprise a URL indicating the location of the corresponding media content in the Signature and Local Media Store 420. In certain instances, the URL may be, for example, “localhost” when the media content is stored in the Signature and Local Media Store 420.

In some embodiments, the semantic signature circuitry 218 may comprise a Signature Maintenance module 430. The Signature Maintenance module 430 may be configured to receive the semantic signature from the Signature Generation Engine 422 and to store the semantic signature in the Signature and Local Media Store 420. The URL data for the semantic signature may be updated as necessary by the Signature Maintenance module 430 once the signature is stored. In example embodiments, the Signature Maintenance module 430 may modify the privacy and access policies, in some instance in conjunction with the DRM/Security/Privacy module 428.

The semantic signature circuitry 218 may further comprise a Media and Signature Upload module 432. The Media and Signature Upload module 432 may be configured to upload the media content, or in some instances one or more media segments of the media content, to an external service. For example, a user may request that the semantic signature circuitry 218 upload the media content to a cloud service such as Facebook™, YouTube™, and/or the like. The Media and Signature Upload module 432 may further upload the corresponding semantic signature generated by the Signature Generation Engine 422. In other embodiments, the semantic signatures for the media content may be maintained in a central repository (e.g., an external repository) rather than at the external service.

The Signature Maintenance module 430 may be configured to keep the information contained within the signature updated. For example, when a user uploads the media content associated with a semantic signature to an external service, the Signature Maintenance module 430 may update the semantic signature to indicate the URL of the location on the external service where the media content may be accessed. In this example, the URL of the location on the external service may either replace or supplement the URLs associated with locations where the media content is stored. In example embodiments, the Signature Maintenance module 430 may modify the semantic signature in the local store and upload the updated semantic signature to the external service. In other embodiments, the Signature Maintenance module 430 may be configured to directly modify the semantic signature stored at the external service (e.g., via a signaling mechanism). The central repository and/or external service may similarly be configured to update the semantic signature in the local store via the same or different means. The Signature Maintenance module 430 may be associated with the Media and Signature Upload module 432 such that the Signature Maintenance module 430 may be alerted any time media content and/or signatures are uploaded or downloaded.

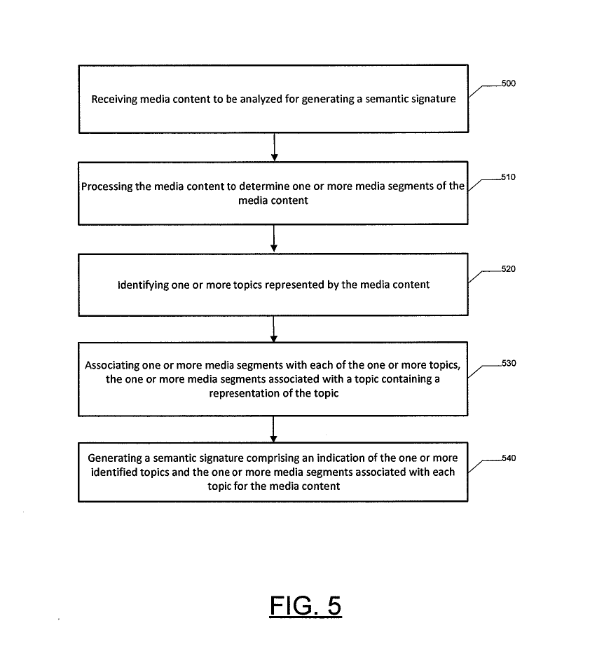

Referring now to FIG. 5, FIG. 5 illustrates a flowchart according to an example method for generating, storing, and/or distributing semantic media signatures for media content according to some example embodiments. The operations illustrated in and described with respect to FIG. 5 may, for example, be performed by, with the assistance of, and/or under the control of one or more of the processor 210, memory 212, user interface 216, or semantic signature circuitry 218. Operation 500 may comprise receiving media content to be analyzed for generating a semantic signature. The processor 210, memory 212, user interface 216, and/or semantic signature circuitry 218 may, for example, provide means for performing operation 500. Operation 510 may comprise processing the media content to determine one or more media segments of the media content. The processor 210, memory 212, user interface 216, and/or semantic signature circuitry 218 may, for example, provide means for performing operation 510. Operation 520 may comprise identifying one or more topics represented by the media content. The processor 210, memory 212, user interface 216, and/or semantic signature circuitry 218 may, for example, provide means for performing operation 520. Operation 530 may comprise associating one or more media segments with each of the one or more topics. The one or more media segments associated with a topic may contain a representation of the topic. The processor 210, memory 212, user interface 216, and/or semantic signature circuitry 218 may, for example, provide means for performing operation 530. Operation 540 may comprise generating a semantic signature for the media content. The semantic signature may comprise an indication of the one or more identified topics and the one or more media segments associated with each topic. The processor 210, memory 212, user interface 216, and/or semantic signature circuitry 218 may, for example, provide means for performing operation 540.

FIG. 5 illustrates a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 212) and executed by a processor in the computing device (for example, by the processor 210). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 202) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 202) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The various example embodiments described herein may provide numerous advantages over the prior art. Certain advantageous embodiments may facilitate bandwidth efficient methods for navigating and/or browsing the media content represented by the semantic signatures without requiring a user to download large amounts of data. Some advantageous embodiments may provide an interface for navigating the media content using the semantic signature. In this regard, the interface may display the one or more topics and/or subtopics represented by the semantic signature, for example in a hierarchical format (e.g., a topic tree). In these embodiments, the interface may further indicate the temporal positions of the media segments associated with each topic. Accordingly, the user may be able to estimate the content of the media without actually downloading the media. In various advantageous embodiments, the interface may further provide a graphical representation of the media content. For example, one or more images or thumbnails of the media segments associated with each topic may be displayed (e.g., as each topic is selected), and/or a URL for a low-bandwidth version of the media segments may be provided by the interface. In this way, a user may quickly preview the media content before deciding whether to download. The user may then, in some instances, download only those topics or media segments they are interested in rather than the entire media content. Such embodiments provide advantages over the prior art which rely mainly on consecutive time-interval based preview and browsing of media content.

According to other advantageous embodiments, a user may be able to quickly and easily search media content prior to downloading. For example, the user may search for one or more keywords in the topic identifiers associated with the media content represented by the semantic signature. Once the desired topics are located, the user may be able to determine the media segments related to those topics and access them. In some advantageous embodiments, the user may be presented with other media content related to the selected media content. For example, the user may be presented with subtopics or parent topics of the selected topic. In another example, the user may be informed of related media identified as siblings in the semantic signature. In this regard, the semantic signature for a first media representation may suggest other media representations which have been tagged with similar topic information by the same or different users.

In other advantageous embodiments, the semantic signatures of various example embodiments described herein, may enable a user to generate remixes of the media content from multiple media sources. In this regard, a user may use the topic information in the semantic signatures of various media representations to select, combine, and rearrange media segments into a remix. For example, the user may be able to generate a new semantic signature for the remix based on the content of the semantic signatures of the source media content. The user may simply generate a new semantic signature for the remix by copying the same URL information from the source semantic signatures for the various topics to be included in the new semantic signature. In this way, the user may not even need to download, copy, or generate any new media content, but rather the URL information in the remix semantic signature may refer to the current location of the media content as specified by the source semantic signatures. In some instances, the semantic signatures of the source media content may be updated to reflect the relationship to the remix semantic signature.

The above described functions may be carried out in many ways. For example, any suitable means for carrying out each of the functions described above may be employed to carry out embodiments of the invention. In one embodiment, a suitably configured processor (for example, the processor 210) may provide all or a portion of the elements. In another embodiment, all or a portion of the elements may be configured by and operate under control of a computer program product. The computer program product for performing the methods of an example embodiment of the invention includes a computer-readable storage medium (for example, the memory 212), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
receiving media content to be analyzed for generating a semantic signature;
processing the media content to determine one or more media segments of the media content;
identifying one or more topics represented by the media content;
associating one or more media segments with each of the one or more topics, wherein the one or more media segments associated with a topic contain a representation of the topic; and
generating a semantic signature for the media content, wherein the semantic signature comprises an indication of the one or more identified topics and the one or more media segments associated with each topic.

2. The method of claim 1, wherein generating the semantic signature further comprises:
generating a unique identifier for the media content; and
including an indication of the unique identifier in the semantic signature.

3. The method of claim 1, wherein the semantic signature comprises an indication of a relationship between a topic and a subtopic.

4. The method of claim 1, wherein the semantic signature comprises one or more links for accessing the media content in one or more locations, and wherein the method further comprises:
uploading the media content to an external repository; and
modifying the semantic signature to include a link to the location of the media content in the external repository.

5. The method of claim 1, wherein processing the media content to determine one or more media segments further comprises one or more of (1) identifying one or more latent patterns in the media content; (2) identifying one or more images in the media content; (3) identifying one or more audio patterns in the media content; (4) identifying sensor information associated with the media content; and (5) identifying contextual information associated with the media content.

6. The method of claim 1, wherein generating the semantic signature further comprises one or more of (1) retrieving a signature pattern template to be used for modeling the format of the semantic signature; (2) retrieving one or more user preferences to be used for generating the semantic signature; and (3) retrieving one or more security or privacy policies to be applied to the semantic signature.

7. The method of claim 1, further comprising:
identifying one or more media segments not associated with a topic;
generating the semantic signature for the media content, wherein the semantic signature comprises an indication of the one or more media segments not associated with a topic.

8. An apparatus comprising at least one processor and at least one memory storing computer program code, wherein the at least one memory and stored computer program code are configured, with the at least one processor, to cause the apparatus to at least:
receive media content to be analyzed for generating a semantic signature;
process the media content to determine one or more media segments of the media content;
identify one or more topics represented by the media content;
associate one or more media segments with each of the one or more topics, wherein the one or more media segments associated with a topic contain a representation of the topic; and
generate a semantic signature for the media content, wherein the semantic signature comprises an indication of the one or more identified topics and the one or more media segments associated with each topic.

9. The apparatus of claim 8, wherein in order to generate the semantic signature the at least one memory and stored computer program code are configured, with the at least one processor, to further cause the apparatus to:
generate a unique identifier for the represented media content; and
include an indication of the unique identifier in the semantic signature.

10. The apparatus of claim 8, wherein the semantic signature comprises an indication of a relationship between a topic and a subtopic.

11. The apparatus of claim 8, wherein the semantic signature comprises one or more links for accessing the media content in one or more locations, and wherein the at least one memory and stored computer program code are configured, with the at least one processor, to cause the apparatus to:
upload the media content to an external repository; and
modify the semantic signature to include a link to the location of the media content in the external repository.

12. The apparatus of claim 8, wherein in order to process the media content to determine one or more media segments the at least one memory and stored computer program code are configured, with the at least one processor, to further cause the apparatus to perform one or more of (1) identifying one or more latent patterns in the media content; (2) identifying one or more images in the media content; (3) identifying one or more audio patterns in the media content; (4) identifying sensor information associated with the media content; and (5) identifying contextual information associated with the media content.

13. The apparatus of claim 8, wherein in order to generate the semantic signature the at least one memory and stored computer program code are configured, with the at least one processor, to further cause the apparatus to perform one or more of (1) retrieving a signature pattern template to be used for modeling the format of the semantic signature; (2) retrieving one or more user preferences to be used for generating the semantic signature; and (3) retrieving one or more security or privacy policies to be applied to the semantic signature.

14. The apparatus of claim 8, wherein the at least one memory and stored computer program code are configured, with the at least one processor, to further cause the apparatus to:
identify one or more media segments not associated with a topic;
generate the semantic signature for the media content, wherein the semantic signature comprises an indication of the one or more media segments not associated with a topic.

15. A computer program product comprising at least one non-transitory computer readable medium having program code stored thereon, wherein the program code, when executed by an apparatus, causes the apparatus at least to:
receive media content to be analyzed for generating a semantic signature;
process the media content to determine one or more media segments of the media content;
identify one or more topics represented by the media content;
associate one or more media segments with each of the one or more topics, wherein the one or more media segments associated with a topic contain a representation of the topic; and
generate a semantic signature for the media content, wherein the semantic signature comprises an indication of the one or more identified topics and the one or more media segments associated with each topic.

16. The computer program product of claim 15, wherein the program code that causes the apparatus to generate the semantic signature further causes the apparatus to:
generate a unique identifier for the represented media content; and
include an indication of the unique identifier in the semantic signature.

17. The computer program product of claim 15, wherein the semantic signature comprises an indication of a relationship between a topic and a subtopic.

18. The computer program product of claim 15, wherein the semantic signature comprises one or more links for accessing the media content in one or more locations; and wherein the program code, when executed by the apparatus, further causes the apparatus at least to:
upload the media content to an external repository; and
modify the semantic signature to include a link to the location of the media content in the external repository.

19. The computer program product of claim 15, wherein the program code that causes the apparatus to process the media content to determine one or more media segments further causes the apparatus to perform one or more of (1) identifying one or more latent patterns in the media content; (2) identifying one or more images in the media content; (3) identifying one or more audio patterns in the media content; (4) identifying sensor information associated with the media content; and (5) identifying contextual information associated with the media content.

20. The computer program product of claim 15, wherein the program code that causes the apparatus to generate the semantic signature further causes the apparatus to perform one or more of (1) retrieving a signature pattern template to be used for modeling the format of the semantic signature; (2) retrieving one or more user preferences to be used for generating the semantic signature; and (3) retrieving one or more security or privacy policies to be applied to the semantic signature.

21. The computer program product of claim 15, wherein the program code, when executed by the apparatus, further causes the apparatus at least to:
identify one or more media segments not associated with a topic;
generate the semantic signature for the media content, wherein the semantic signature comprises an indication of the one or more media segments not associated with a topic.

22. An apparatus comprising:
means for receiving media content to be analyzed for generating a semantic signature;
means for processing the media content to determine one or more media segments of the media content;
means for identifying one or more topics represented by the media content;
means for associating one or more media segments with each of the one or more topics, wherein the one or more media segments associated with a topic contain a representation of the topic; and
means for generating a semantic signature for the media content, wherein the semantic signature comprises an indication of the one or more identified topics and the one or more media segments associated with each topic.

23. The apparatus of claim 22, wherein the means for generating the semantic signature further comprises:
means for generating a unique identifier for the media content; and
means for including an indication of the unique identifier in the semantic signature.

24. The apparatus of claim 22, wherein the semantic signature comprises an indication of a relationship between a topic and a subtopic.

25. The apparatus of claim 22, wherein the semantic signature comprises one or more links for accessing the media content in one or more locations, and wherein the apparatus further comprises:
means for uploading the media content to an external repository; and
means for modifying the semantic signature to include a link to the location of the media content in the external repository.

26. The apparatus of claim 22, wherein the means for processing the media content to determine one or more media segments further comprises means for one or more of (1) identifying one or more latent patterns in the media content; (2) identifying one or more images in the media content; (3) identifying one or more audio patterns in the media content; (4) identifying sensor information associated with the media content; and (5) identifying contextual information associated with the media content.

27. The apparatus of claim 22, wherein the means for generating the semantic signature further comprises means for one or more of (1) retrieving a signature pattern template to be used for modeling the format of the semantic signature; (2) retrieving one or more user preferences to be used for generating the semantic signature; and (3) retrieving one or more security or privacy policies to be applied to the semantic signature.

28. The apparatus of claim 22, further comprising:
means for identifying one or more media segments not associated with a topic;
means for generating the semantic signature for the media content, wherein the semantic signature comprises an indication of the one or more media segments not associated with a topic.

29. (canceled)
